(19) United States
(12) Patent Application Publication
(10) Pub. No.: US 2001/0001410 A1
(43) Pub. Date: May 24, 2001

(54) SINGLE-FACED CORRUGATED FIBERBOARD SHEET MANUFACTURING APPARATUS

(76) Inventors: HIROSHI ISHIBUCHI, HIROSHIMA-KEN (JP); KAZUKIYO KOHNO, HIROSHIMA-KEN (JP); MASATSUGU SUZUKI, TOKYO (JP)

Correspondence Address: ARMSTRONG,WESTERMAN, HATTORI,, MCLELAND & NAUGHTON, LLP, 1725 K STREET, NW, SUITE 1000, WASHINGTON, DC, 20006, US

(21) Appl. No.: 09/056,873

(22) Filed: Apr. 8, 1998

(30) Foreign Application Priority Data
Apr. 10, 1997 (JP) HEI 9-92359

(51) Int. Cl. B32B 3/28; B32B 3/30; B31F 1/00

(52) U.S. Cl. 156/210; 156/472; 428/185

(57) ABSTRACT

The present invention relates to a single-faced corrugated fiberboard sheet manufacturing apparatus and is for the purpose of manufacturing a high-quality single-faced corrugated fiberboard sheet without the occurrence of a pitch slippage or a phase shift among a plurality of corrugating mediums, the breakage of flutes and the occurrence of press marks. The manufacturing apparatus is composed of a plurality of corrugating rolls provided for each of a plurality of corrugating mediums and having flutes different in height from each other to shape the plurality of corrugating mediums into corrugated configurations with flutes different in height from each other, an applicator roll engaged with all of the plurality of corrugating rolls to guide the plurality of corrugating mediums shaped into the corrugated configurations in an adhered condition, and a pressure unit disposed in an opposed relation to the applicator roll to pressurize the plurality of corrugating mediums and a liner to assist adhesion therebetween. The applicator roll has flutes equal to or higher than the highest flute of the flutes of the plurality of corrugating rolls, and adhesion between the plurality of corrugating mediums and the adhesion of the liner to the plurality of corrugating mediums are conducted on the same applicator roll.

### BACKGROUND OF THE INVENTION

1. Field of the Invention

The present invention relates to a signal-faced corrugated fiberboard sheet manufacturing apparatus which bonds a plurality of corrugating mediums and a liner together to manufacture a single-faced corrugated fiberboard sheet comprising a plurality of corrugating medium layers.

2. Description of Related Art

So far, a single-faced corrugated fiberboard sheet manufacturing apparatus has been developed to bond a plurality of layers of corrugating mediums and a liner together to manufacture a single-faced corrugated fiberboard sheet.

Referring to FIG. 3, a description will be made hereinbelow of a single-faced corrugated fiberboard sheet manufacturing apparatus, for example, which bonds two corrugating mediums and a liner together to make a single-faced corrugated fiberboard sheet including two layers of corrugating mediums.

As shown in FIG. 3, the single-faced corrugated fiberboard sheet manufacturing apparatus is equipped with a first single facer 203 for bonding a liner 12 and first corrugating medium 10 together to form a single-faced corrugated fiberboard sheet 13′ having one layer of corrugating medium, and a second single facer 208 disposed on the downstream side of the first single facer 203 for bonding the single-faced corrugated fiberboard sheet 13′ and second corrugating medium 11 to form a single-faced corrugated fiberboard sheet 13 comprising two layers of corrugating mediums.

The first single facer 203 is composed of an upper roller 204 having low flutes, a pressure roller 205 disposed to gear with the upper roller 204 and made to press the first corrugating medium 10 against the upper roller 204 to pressurize it, a gluing roller 206 for applying a paste to flute peak portions of the first corrugating medium 10 guided along an outer circumferential surface of the upper roller 204, and a pressure roller 207 for pressurizing the first corrugating medium 10 and the liner 12 while adequately heating to join them to each other. The first corrugating medium 10 having a corrugated configuration with low flutes is adhered to the liner 12 to form the single-faced corrugated fiberboard sheet 13′ comprising one corrugating medium layer.

The liner 12 is supplied in a manner of feeding rolled paper 202 mounted on a mill roll stand 201.

The second single facer 208 is made up of an upper roller 209 having high flutes, a pressure roller 210 disposed to engage with the upper roller 209 to press the second corrugating medium 11 against the upper roller 209 for pressurizing it, a gluing roller 211 for applying a paste to the flute peak portions of the second corrugating medium 11 guided along an outer circumferential surface of the upper roller 209, and a pressure roller 212 for pressurizing the second corrugating medium 11 and the single-faced corrugated fiberboard sheet 13′ while adequately pressurizing, to bond them together. The single-faced corrugated fiberboard sheet 13′ formed by the first single facer 203 is adhered to the second corrugating medium 11 having a corrugated configuration with high flutes, thereby producing the single-faced corrugated fiberboard sheet 13 having two corrugating medium layers.

The single-faced corrugated fiberboard sheet manufacturing apparatus thus constructed operates as follows.

That is, in the first single facer 203, the first corrugating medium 10 from the non-shown mill roll stand is introduced into the gap between the upper roller 204 and the pressure roller 205 where low flutes are made on the first corrugating medium 10 which in turn, is shaped into a corrugated configuration. The first corrugating medium 10 thus shaped into the corrugated configuration with low flutes is guided along the outer circumferential surface of the upper roller 204 and a paste is applied through the gluing roller 206 to the flute peak portions of the first corrugating medium 10, and subsequently, is conveyed into between the pressure roller 207 and the upper roller 204.

Between the pressure roller 207 and the upper roller 204, the first corrugating medium 10 shaped into a corrugated configuration with low flutes is adhered to the liner 12 coming from a mill roll stand 201 in a manner of being pressed while heated appropriately, thereby forming the one-layer single-faced corrugated fiberboard sheet 13′ comprising the first corrugating medium 10 shaped into a corrugated configuration with low flutes. This one-layer single-faced corrugated fiberboard sheet 13′ is delivered toward the second single facer 208 disposed on its downstream side.

Furthermore, in the second single facer 208, the second corrugating medium 11 from a non-shown mill roll stand is introduced into the gap between the upper roller 209 and the pressure roller 210 where high flutes are formed on the second corrugating medium 11 so that the second corrugating medium 11 is shaped into a corrugated configuration. The second corrugating medium 11 thus shaped into a corrugated configuration with high flutes is guided along the outer circumferential surface, and receives a paste at its flute peak portions from the gluing roller 211, and further, is introduced into between the pressure roller 208 and the upper roller 209.

Between the pressure roller 212 and the upper roller 209, the second corrugating medium 11 shaped into a corrugated configuration with high flutes is adhered to the one-layer single-faced corrugated fiberboard sheet 13′ formed in the first single facer 203 in a manner of being pressed while heated appropriately, thus forming the two-layer single-faced corrugated fiberboard sheet 13 having the first corrugating medium 10 shaped into a corrugated configuration with low flutes and the second corrugating medium 11 shaped into a corrugated configuration with high flutes.

The two-layer single-faced corrugated fiberboard sheet 13 formed in this way is adhered to the liner 14 by means of a non-shown double facer located on the downstream side thereof so that produced is a double-faced corrugated fiberboard sheet 15 shown in FIG. 2.

The double-faced corrugated fiberboard sheet 15 made in this way, as shown in FIG. 2, has a structure in which the two corrugating mediums: the first corrugating medium 10 and the second corrugating medium 11 shaped into corrugated configurations with different heights of flutes are adhered to each other at the same pitch P₀ between the liners 12, 14.

More specifically, the first corrugating medium 10 formed at the pitch P₀ to have flutes whose height is H₁ (lower flutes) is adhered onto the surface of the liner 12 and further one-side flute peak portions of the second corrugating medium 11 having flutes of height H₂ (higher flutes) are adhered onto the rear surfaces of the flute peak portions of the first corrugating medium 10, and moreover, the other-side flute peak portions of the second corrugating medium 11 are adhered onto the surface of the liner 14.

In such a prior single-faced corrugated fiberboard sheet manufacturing apparatus, for the purpose of manufacturing a single-faced corrugated fiberboard sheet having a high quality but not having wrinkles or the like, it is desirable to maintain the tension to be applied to the liner 12 to a given value. For this reason, the tension to the liner 12 to be fed into the first single facer 203 is made through the adjustment of the rotating speed of the mill roll stand 201 or the like.

However, in the first single facer 203, since the liner 12 and the first corrugating medium 10 are adhered to each other while being held between the pressure roller 207 and the upper roller 204, difficulty is experienced to adjust the tensions to the liner 12 to a given value on the upstream side of the first single facer 203 and on the downstream side thereof. That is, although maintaining the tension to the liner 12 to the given value is possible on the upstream side of the first single facer 203, maintaining that tension becomes difficult on the downstream side of the first single facer 203, and there is a possibility that the tension decreases or vanishes.

For this reason, in the second single facer 208, the pitch slippage or phase shift takes place between the flute peak portions of the first corrugating medium 10 shaped into a corrugated configuration with low flutes and the flute peak portions of the second corrugating medium 11 shaped into a corrugated configuration with high flutes in the single-faced corrugated fiberboard sheet 13′, which makes it difficult to adhere them at an appropriate position.

In more detail, in the first single facer 203, although, immediately after the first corrugating medium 10 with low flutes in a corrugated condition is adhered onto the liner 12, for example as shown in FIG. 4, a given number of (in this case, 3) flute peak portions of the first corrugating medium 10 having a pitch Pₐ between the flute peak portions per a given length M₁ are an adhered condition to the liner 12 in a state where the liner 12 is maintained to undergo a given tension, the tension to the liner 12 thereafter decreases or vanishes, with the result that the given length M₁ of the liner 12 is shortened to M₂ as shown in FIG. 5. In accordance with the shortening of the liner 12, the pitch Pₐ between the flute peak portions decreases to a pitch P_{b}, which can cause the number of the flute peak portions of the first corrugating medium 10 to be adhered per the given length M₁ to exceed the given value (in the illustration, 4).

Accordingly, although the pitch taken for when adhering the second corrugating medium 11 in a corrugated condition with high flutes in the second single facer 208 is set to be equal to the pitch taken for when adhering the first corrugating medium 10 in a corrugated condition with low flutes in the first single facer 203, at the time that the single-faced corrugated fiberboard sheet 13′ is introduced into the second single facer 208, the flute peak portion pitch of the first corrugating medium 10 varies, with the result that difficulty is encountered to bond the one-layer single-faced corrugated fiberboard sheet 13′ and the second corrugating medium 11 together at an appropriate position, which makes it difficult to produce a high-quality single-faced corrugated fiberboard sheet 13 comprising the two corrugating medium layers.

That is, if the flute peak portion pitch of the first corrugating medium 10 and the flute peak portion pitch of the second corrugating medium 11 differ from each other as mentioned above, the phase shift also occurs between the first corrugating medium 10 in the corrugated condition with low flutes and the second corrugating medium 11 in the corrugated condition with high flutes.

More specifically, as shown in FIG. 6, if the pitch P₂ between the flute peak portions of the second corrugating medium 11 decreases with respect to the pitch P₁ between the flute peak portions of the first corrugating medium 10, or on the contrary, if the pitch P₂ between the flute peak portions of the second corrugating medium 11 increases with respect to the pitch P₁ between the flute peak portions of the first corrugating medium 10, a slippage between the corrugated configurations of the first corrugating medium 10 and the second corrugating medium 11, so that a phase shift δ takes place.

When the phase shift δ takes place between the first corrugating medium 10 and the second corrugating medium 11 in the second single facer 208, difficulty is encountered to bond the first corrugating medium 10 and the second corrugating medium 11 together at an appropriate position, so that the single-faced corrugated fiberboard sheet (double-faced corrugated fiberboard sheet) with a plurality of corrugating medium layers formed for the purpose of enhancing the cushion effect or the strength can not fulfill the original function.

As such a single-faced corrugated fiberboard sheet manufacturing apparatus for manufacturing a single-faced corrugated fiberboard sheet comprising a plurality of corrugating medium layers, there is a technique disclosed, for example, in Japanese Examined Patent Publication No. 7-110525.

In this technique, two take-up rollers are provided in an opposed relation to each other, and the flute peak portions of a corrugating medium taken up by one roller are adhered to the flute peak portions of a corrugating medium taken by the other roller, with both being conveyed to a carrier roller and further adhered to a liner while being guided by the carrier roller.

However, although it is written that this carrier roller can be constructed as a cylindrical roller with a groove which is designed to support and restrict the corrugating mediums adhered to each other, no consideration is given to a means for preventing the breakage of the flutes. Thus, there is a possibility of the occurrence of the breakage of the flutes when the liner is adhered to the two corrugating mediums adhered to each other after the process of bonding the respective flute peak portions of the corrugating mediums together.

That is, in general, whether the breakage of the flutes occurs or not depends upon the pressing force applied to the corrugating medium at the adhesion. In the case of such a technique, in order to surely accomplish the adhesion therebetween, it is necessary to ensure the pressing force, whereas it is desirable to reduce the pressing force as much as possible with a view to preventing the breakage of the flutes.

Accordingly, if achieving the certain adhesion therebetween, considerable difficulty is encountered to adjust the pressing force to prevent the breakage of the flutes when the liner is adhered to the corrugating mediums adhered to each other, with the result that it is impossible to avoid the breakage of the flutes.

In addition, in this technique, the liner is made to be adhered to the adhered corrugated mediums while being guided by a guide roller, and therefore, since the pressing force to the liner varies, press marks may take place.

### SUMMARY OF THE INVENTION

The present invention has been developed in order to eliminate these problems, and it is therefore an object of this invention to provide a single-faced corrugated fiberboard sheet manufacturing apparatus which is capable of bonding a plurality of flute-made corrugating mediums together with no occurrence of a pitch slippage or phase shift therebetween and capable of manufacturing a high-quality single-faced corrugated fiberboard sheet while preventing the breakage of flutes and the occurrence of press marks.

For this purpose, in accordance with the present invention, a single-faced corrugated fiberboard sheet manufacturing apparatus for manufacturing a single-faced corrugated fiberboard sheet by bonding a plurality of corrugating mediums and a liner together is composed of a plurality of corrugating rolls provided for each of the plurality of corrugating mediums and equipped with flutes different in height from each other to shape the plurality of corrugating mediums into corrugated configurations with flutes different in height from each other, an applicator roll engaged with all of the plurality of corrugating rolls and made to guide the plurality of corrugating mediums, formed into corrugated configurations, in an adhered condition, and a pressure unit disposed in an opposed relation to the applicator roll to pressurize the plurality of corrugating mediums and the liner to assist the adhesion therebetween, wherein the applicator roll has flutes equal to or higher than the highest flute of the flutes of the plurality of corrugating rolls, and the adhesion between the plurality of corrugating mediums and the adhesion between the plurality of corrugating mediums and the liner are conducted on said same applicator roll.

Whereupon, the plurality of corrugating mediums are adhered while being guided on the same applicator roll. Thus, it is possible to manufacture a high-quality single-faced corrugated fiberboard sheet with the plurality of corrugating medium layers in a state where no pitch slippage or no phase shift occurs between the plurality of corrugating mediums adhered to each other. In addition, since the all the adhesions (the adhesion between the corrugating mediums and the adhesion between the corrugating mediums and the liner) necessary for manufacturing the single-faced corrugated fiberboard sheet are done on the same applicator roll, a compact apparatus is achievable.

Preferably, the pressure unit is provided with a pressure belt for bringing the plurality of corrugating mediums, guided in the adhered condition along the outer circumferential surface of the applicator roll, and the liner into pressurizing contact with the applicator roll, and belt rollers around which the pressure belt is wound.

In this case, the adhesion of the liner to the plurality of corrugating mediums is made at a portion where the pressure belt is brought into contact with the applicator roll under pressure.

Owing to this construction, the adhered corrugating mediums and the liner are pressed by the pressure belt to be adhered to each other, and therefore, the pressurization by an excessive pressure is avoidable, so that the press marks which tend to occur when applying a pressure to the liner do not take place.

In addition, it is preferable that the adhesion among the plurality of corrugating mediums is made in a manner that the flute peak portions of the corrugating mediums shaped into a corrugated configuration with high flutes are adhered to the bottom portions between the flutes on the corrugating mediums shaped into a corrugated configuration with low flutes.

Furthermore, preferably, the adhesion among the plurality of corrugating mediums is made at a portion where the applicator roll engages with the corrugating roll with low flutes.

Still further, preferably, a plurality of pressure rollers are provided which respectively engage with the plurality of corrugating rolls, and the plurality of corrugating mediums are introduced into between the plurality of pressure rollers and the plurality of corrugating rolls to form corrugated configurations with different flutes on the plurality of corrugating mediums, respectively.

Besides, of the plurality of corrugating rolls, the corrugating roll with high flutes are located on the upstream side in the rotating direction of the applicator roll, and the corrugating rolls with lower flutes are provided in order toward the downstream side in the rotating direction.

With this construction, the adhesion among the corrugating mediums or the adhesion between the corrugating mediums and the liner is achievable in a state where the flutes are engaged with the flutes formed between the flutes of the applicator roll, with the result that the flutes of the respective corrugating mediums do not interfere with each other and are all free from the breakage.

Moreover, in accordance with this invention, in a single-faced corrugated fiberboard sheet manufacturing method of producing a single-faced corrugated fiberboard sheet by adhering a plurality of corrugating mediums to a liner, the corrugating mediums shaped by a corrugating roll with high flutes into a corrugated configuration with high flutes is introduced onto an applicator roll gearing with the corrugating roll with high flutes and guided by the applicator roll, while the corrugating mediums shaped by a corrugating roll with low flutes into a corrugated configuration with low flutes is introduced onto the applicator roll engaging with the corrugating roll with low flutes so that it comes into an adhered condition with the corrugating mediums shaped into the corrugated configuration with high flutes and guided by the applicator roll, and after the corrugating mediums shaped into the corrugated configuration with high flutes and the corrugating mediums shaped into the corrugated configuration with low flutes are adhered to each other on the applicator roll engaging with the corrugating roll with low flutes, the adhered corrugating mediums are guided by the applicator roll in a state where the flutes of the adhered corrugating mediums are put in the flutes formed between the flutes of the applicator roll with high flutes to maintain the configurations, and further, the liner is introduced onto the applicator roll to come into an adhered condition with the adhered corrugating mediums guided by the applicator roll, and the liner and the adhered corrugating mediums are pressurized by the pressure unit to be adhered to each other on the same applicator roll.

Whereupon, since the plurality of corrugating mediums are adhered to each other while being guided on the same applicator roll, neither a pitch slippage nor a phase shift occurs between the plurality of corrugating mediums to be adhered to each other, so that it is possible to manufacture a high-quality single-faced corrugated fiberboard sheet comprising a plurality of corrugating medium layers. In addition, since all the adhesions (the adhesion among the corrugating mediums and the adhesion between the corrugating mediums and the liner) needed for manufacturing a single-faced corrugated fiberboard sheet can be done on the same applicator roll, a compact apparatus is producible.

### BRIEF DESCRIPTION OF THE DRAWINGS

FIG. 1 is a side elevational view illustratively showing a schematic construction of a single-faced corrugated fiberboard sheet manufacturing apparatus according to an embodiment of the present invention;

FIG. 2 is a cross-sectional view illustratively showing a double-faced corrugated fiberboard sheet comprising a plurality of corrugating mediums;

FIG. 3 is a side elevational view illustratively showing a prior single-faced corrugated fiberboard sheet manufacturing apparatus;

FIG. 4 is an illustrative cross-sectional view useful for describing the problems in a pitch slippage arising with the prior single-faced corrugated fiberboard sheet manufacturing apparatus;

FIG. 5 is an illustrative cross-sectional view available for describing the problems in a pitch slippage arising with the prior single-faced corrugated fiberboard sheet manufacturing apparatus;

FIG. 6 is an illustrative illustration useful for explaining the problems in a phase shift arising with the prior single-faced corrugated fiberboard sheet manufacturing apparatus; and

FIG. 7 is an illustrative illustration useful for explaining the problems in a phase shift arising with the prior single-faced corrugated fiberboard sheet manufacturing apparatus.

### DESCRIPTION OF THE PREFERRED EMBODIMENTS

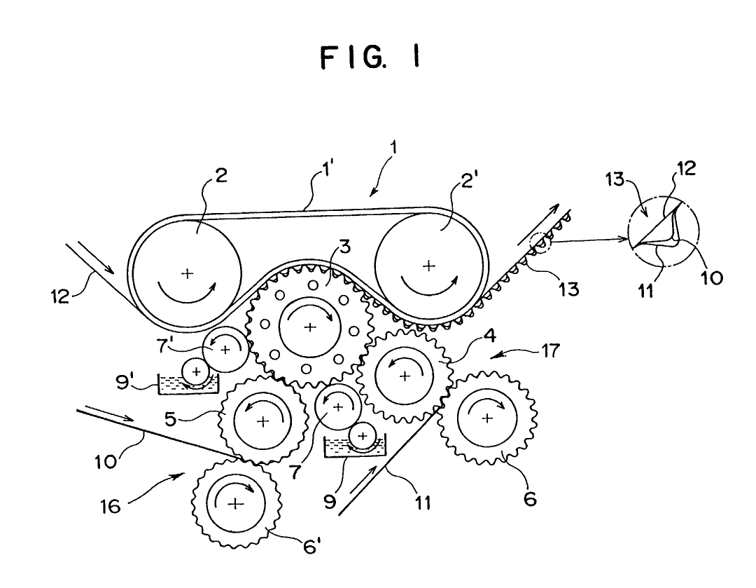

Referring to the drawings, a description will be made hereinbelow of an embodiment of the present invention. FIG. 1 shows a single-faced corrugated fiberboard sheet manufacturing apparatus according to an embodiment of this invention.

The single-faced corrugated fiberboard sheet manufacturing apparatus according to this embodiment is designed such that two corrugating mediums and a liner are adhered to each other to produce a single-faced corrugated fiberboard sheet comprising two corrugating medium layers.

This single-faced corrugated fiberboard sheet manufacturing apparatus is, as shown in FIG. 1, composed of a first corrugating medium flute making section 16 for shaping first corrugating medium 10 into a corrugated configuration with low flutes, a second corrugating medium flute making section 17 for shaping second corrugating medium 11 into a corrugated configuration with high flutes, an upper roller 3 serving as an applicator roll for guiding the second corrugating medium 11 and the first corrugating medium 10 shaped into corrugated configurations, and a pressure unit 1 for adhering the first corrugating medium 10 and the second corrugating medium 11 adhered to each other to a liner 12 while pressurizing.

Furthermore, the adhesion between the first corrugating medium 10 and the second corrugating medium 11 and the adhesion between the adhesion of the first and second corrugating mediums 10, 11 and the liner 12 are made on the same upper roller 3.

The first corrugating medium flute making section 16 comprises a first lower roller (corrugating roll) 5 having low flutes, and a pressure roller 6′ having flutes equal in height to those of the first lower roller 5, with the first corrugating medium 10 being introduced into between the first lower roller 5 and the pressure roller 6′. In addition, the first corrugating medium 10 introduced into between the first lower roller 5 and the pressure roller 6′ is pressed by the pressure roller 6′ against the first lower roller 5 to be pressurized so that it is shaped into a corrugated configuration with low flutes. Incidentally, in FIG. 1, the arrows indicated with rollers represent the rotating directions of the rollers, while the arrows indicated with the liner 12, the first corrugating medium 10 and the second corrugating medium 11 denote the introducing directions thereof.

The first lower roller 5 of the first corrugating medium flute making section 16 is disposed to engage with the upper roller 3, and the first corrugating medium 10 shaped by the first corrugating medium flute making section 16 into a corrugated configuration with low flutes is guided along the outer circumferential surface of the first lower roller 5 in its rotating direction to be introduced into between the first lower roller 5 and the upper roller 3.

The second corrugating medium flute making section 17 comprises a second lower roller (corrugating roll) 4 having high flutes, and a pressure roller 6 having flutes equal in height to those of the second lower roller 4, with the second corrugating medium 11 being introduced into between the second lower roller 4 and the pressure roller 6. Further, the second corrugating medium 11 introduced into between the second lower roller 4 and the pressure roller 6 is pressed by the pressure roller 6 against the second lower roller 4 to be pressurized so that it is shaped into a corrugated configuration with high flutes.

The second lower roller 4 of the second corrugating medium flute making section 17 is made to gear with the upper roller 3, and the second corrugating medium 11 shaped by the second corrugating medium flute making section 17 into a corrugated configuration with high flutes is guided along the outer circumferential surface of the second lower roller 4 in its rotating direction to be introduced into between the second lower roller 4 and the upper roller 3.

The upper roller 3 guides the second corrugating medium 11, shaped by the second corrugating medium flute making section 17 into a corrugated configuration with high flutes, toward the first corrugating medium flute making section 16 side to be adhered to the first corrugating medium 10 shaped by the first corrugating medium flute making section 16 into a corrugated configuration with low flutes, and thereafter, guides the adhesion of the second corrugating medium 11 formed to have high flutes and the first corrugating medium 10 formed to have low flutes toward the pressure unit 1 side.

The outer circumference of the upper roller 3 has flutes corresponding to the higher one of the flutes of the lower rollers 4, 5, that is, equal in height to that of the second lower roller 4, so as to engage with the first lower roller 5 of the first corrugating medium flute making section 16 disposed under the upper roller 3 and further with the second lower roller 4 of the second corrugating medium flute making section 17 disposed under the upper roller 3.

Furthermore, for the conveyance, both the high flutes formed in a corrugated configuration on the second corrugating medium 11 and the low flutes formed in a corrugated configuration on the first corrugating medium 10 are placed in the flutes made between the high flutes of the upper roller 3. That is, the upper roller 3 guides and conveys the second corrugating medium 11 or the adhesion of the second corrugating medium 11 and the first corrugating medium 10, and at this time, accomplishes the phase adjustment between the flutes of the first corrugating medium 10 and the flutes of the second corrugating medium 11 and further keeps them to avoid the breakage of the flutes thereof when bonding the second corrugating medium 11 and the first corrugating medium 10 together or when bonding the adhesion of the first corrugating medium 10 and the second corrugating medium 11 and the liner 12 together.

A gluing machine 9 including a gluing roller 7 is disposed at a portion being in an opposed relation to the upper roller 3 between the second corrugating medium flute making section 17 and the first corrugating medium flute making section 16. A paste is applied through the use of the gluing roller 7 of the gluing machine 9 to the flute peak portions of the second corrugating medium 11 flute-shaped by the second corrugating medium flute making section 17.

Furthermore, at a portion where the upper roller 3 engages with the first lower roller 5 of the first corrugating medium flute making section 16, the flute peak portions of the second corrugating medium 11 guided along its outer circumferential surface in its rotating direction are adhered to the flute portions of the first corrugating medium 10 flute-shaped by the first lower roller 5 of the first corrugating medium flute making section 16.

Still further, the pressure unit 1 is located above the upper roller 3 to be in an opposed relation thereto, and the adhesion of the first corrugating medium 10 and the second corrugating medium 11 guided along the outer circumferential surface of the upper roller 3 is pressed together with the liner 12 so that they are adhered to each other.

Thus, a gluing machine 9′ including a gluing roller 7′ is disposed at a portion in an opposed relation to the upper roller 3 and on the upstream side of a portion where the pressure unit 1 is brought into pressurizing contact with the upper roller 3, and a paste is applied to the rear surface sides of the flute portions of the first corrugating medium 10 by means of the gluing roller 7′ of the gluing machine 9′. On the other hand, the flute peak portions of the second corrugating medium 11 are adhered to the front surface sides of the flute portions of the first corrugating medium 10.

The pressure unit 1 is composed of a pressure belt 1′ and belt rollers 2, 2′ around which the pressure belt 1′ is wound, with the pressure belt 1′ being driven by the belt rollers 2. 2′. The lower portions of the belt rollers 2, 2′ are disposed to be below an upper portion of the upper roller 3, and the pressure belt 1′ wound around the belt rollers 2. 2′ are brought into pressurizing contact with an upper portion of the upper roller 3.

The liner 12 is introduced into between the pressure belt 1′ and the upper roller 3 to be brought into pressurizing contact with each other, and the liner 12 and the first and second corrugating mediums 10, 11 guided along the outer circumferential surface of the upper roller 3 in its rotating direction are pressed by the pressure belt 1′ against the upper roller 3 side to be adhered to each other.

In this case, since the flutes are made on the outer circumferential surface of the upper roller 3, even if being pressed by the pressure belt 1′, the flutes of the first corrugating medium 10 or the second corrugating medium 11 are not broken, and the flute peak portions of the first corrugating medium 10 can desirably be adhered onto the liner 12.

Incidentally, the belt rollers 2, 2′, the upper roller 3, the second lower roller 4, the first lower roller 5 and the pressure rollers 6, 6′ are made to rotate in a synchronizing condition.

Since the single-faced corrugated fiberboard sheet manufacturing apparatus according to this embodiment is constructed as mentioned above, the manufacturing of a single-faced corrugated fiberboard sheet by this apparatus is conducted as follows.

First of all, as shown in FIG. 1, in the second corrugating medium flute making section 17 of this apparatus, the second corrugating medium 11 from a non-shown mill roll stand is introduced into between the second lower roller 4 with high flutes and the pressure roller 6 with high flutes so that the second corrugating medium 11 is shaped into a corrugated configuration with high flutes. Thereafter, the second corrugating medium 11 shaped into a corrugated configuration with high flutes is fed onto the upper roller 3, that is, into the gap between the second lower roller 4 and the upper roller 3.

Subsequently, the second corrugating medium 11 shaped into the corrugated configuration with high flutes is guided along the outer circumferential surface of the upper roller 3 in its rotating direction while a paste is applied to the flute peak portions of the second corrugating medium 11 by the gluing roller 7 of the gluing machine 9, and then, the second corrugating medium 11 is introduced into the gap between the first lower roller 5 and the pressure roller 6′ of the first corrugating medium flute making section 16.

On the other hand, the first corrugating medium 10 coming from a non-shown mill roll stand is introduced into the gap between the first lower roller 5 with low flutes and the pressure roller 6′ with low flutes so that the first corrugating medium 10 is shaped by the first corrugating medium flute making section 16 into a corrugated configuration with low flutes. The first corrugating medium 10 shaped into the corrugated configuration with low flutes is introduced onto the upper roller 3, that is, into the gap between the first lower roller 5 and the upper roller 3 to come into an adhered condition with the second corrugating medium 11 guided on the upper roller 3.

Furthermore, the first corrugating medium 10 shaped by the first corrugating medium flute making section 16 into the corrugated configuration with low flutes and the second corrugating medium 11 shaped by the second corrugating medium flute making section 17 into the corrugated configuration with high flutes are adhered to each other in a manner of being pressed on the upper roller 3 engaging with the first lower roller 5 with low flutes. That is, the flute portions of the first corrugating medium 10 shaped into the corrugated configuration with low flutes and the paste-applied flute peak portions of the second corrugating medium 11 shaped into the corrugated configuration with high flutes are adhered to each other in a way of being pressed by the flutes of the upper roller 3 and the flutes of the first lower roller 5. At this time, the flutes of both the corrugating mediums 10, 11 are adhered to each other in a state of being certainly phase-adjusted by the flutes of the upper roller 3.

Secondly, the corrugating mediums 10, 11 adhered to each other are guided along the outer circumferential surface of the outer roller 3 in its rotating direction in a state where the flutes of the corrugating mediums 10, 11 are put in the flutes between the flutes of the upper roller 3 with high flutes to maintain their configurations, and after a paste is applied to the rear surfaces of the bottom portions between the flutes of the first corrugating medium 10 by the gluing roller 7′ of the gluing machine 9′, the corrugating mediums 10, 11 are introduced into the gap between the upper roller 3 and the pressure belt 1′.

On the other hand, the liner 12 coming from a non-shown mill roll stand is introduced into the gap between the upper roller 3 and the pressure belt 1′ to come into an adhered condition with the adhered corrugating mediums 10, 11 guided by the upper roller 3. Further, the liner 12 and the corrugating mediums 10, 11 adhered to each other are pressurized with a pressing force by the pressure belt 1′ to be adhered to each other on the same upper roller 3.

Thus, the two-layer single-faced corrugated fiberboard sheet 13 is formed which comprises the first corrugating medium 10 shaped into the corrugated configuration with low flutes and the second corrugating medium 11 shaped into the corrugated configuration with high flutes. In this case, since the flutes of the formed corrugated configurations of the first corrugating medium 10 and the second corrugating medium 11 are protected in a manner of being put in the flutes defined between the flutes of the upper roller 3, they are not broken by the pressing force of the pressure belt 1′.

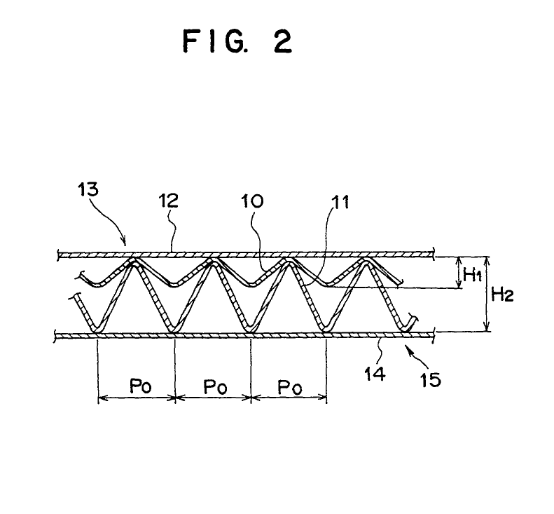

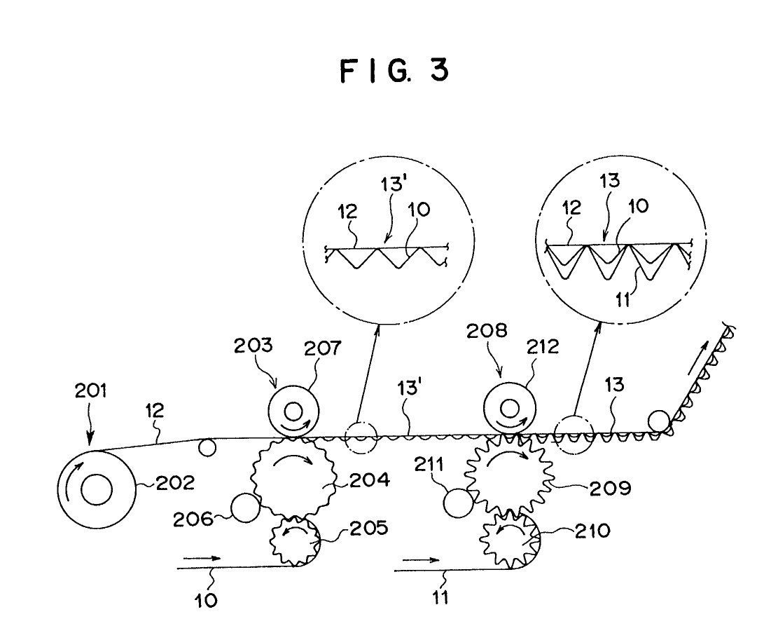

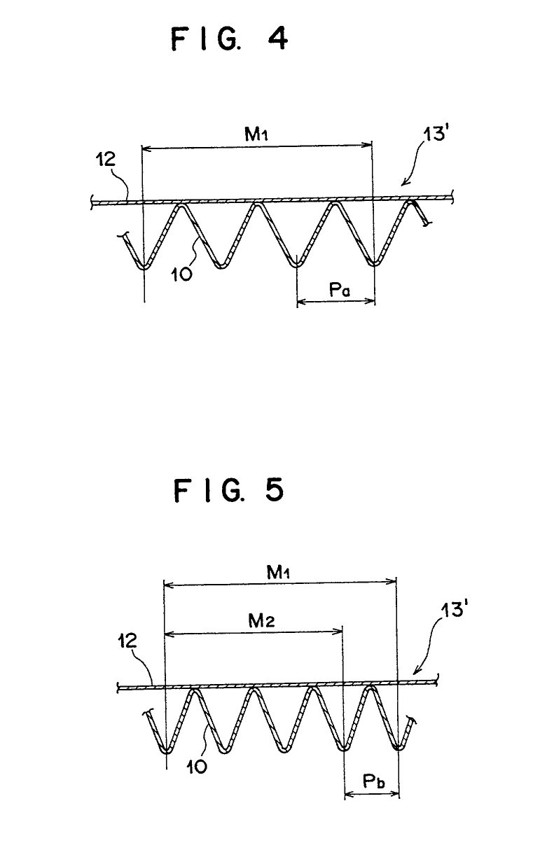

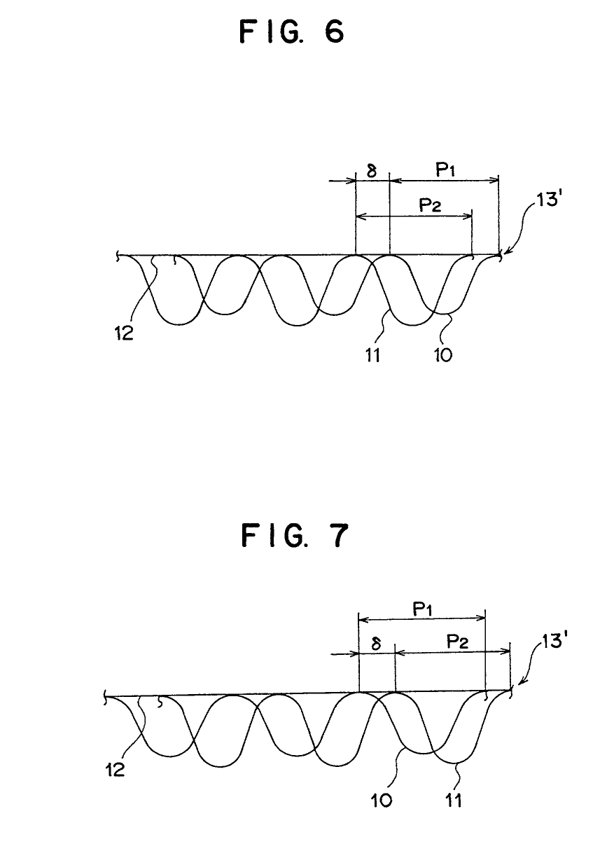

The two-layer single-faced corrugated fiberboard sheet 13 thus formed is adhered to a liner 14 in a non-shown double facer situated on the downstream side thereof, thus producing a double-faced corrugated fiberboard sheet 15 (see FIG. 2).

As described above, according to this single-faced corrugated fiberboard sheet manufacturing apparatus, since the first corrugating medium 10 and the second corrugating medium 11 are adhered to each other while being guided on the same upper roller 3, the pitch slippage or phase shift does not occur between the first corrugating medium 10 and the second corrugating medium 11, with the result that a high-quality single-faced corrugated fiberboard sheet is produicible. Accordingly, there is not need to perform the pitch slippage or phase shift adjustment between the corrugating mediums 10, 11. which allows no need for a phase-shift correcting mechanism or the like.

Although the adhesion of the first and second corrugating mediums 10, 11 and the liner 12 are pressed by the pressure belt 1′ to be adhered to each other, in this case, the pressing force due to the pressure belt 1′ is easily applicable uniformly and softly thereto, and an excessive pressing force thereon is avoidable. Accordingly, the press marks which tends to occur when applying a pressure to the liner 12 do not take place, thus resulting in the production of a high-quality single-faced corrugated fiberboard sheet. In addition, the pressing by the pressure belt 1′ can reduce the noises occurring when the adhesion of the first and second corrugating mediums 10, 11 and the liner 12 are adhered to each other.

Furthermore, the second corrugating medium 11 shaped into the corrugated configuration with high flutes is first introduced onto the upper roller 3 with high flutes and the first corrugating medium 10 shaped into the corrugated configuration with low flutes is then introduced thereonto, and the adhesion of the first and second corrugating mediums 10, 11 and the liner 12 are pressed in a state where the high flutes of the second corrugating medium 11 and the low flutes of the first corrugating medium 10 are put in the flutes defined between the flutes of the upper roller 3, and therefore, the flutes of the first corrugating medium 10 and the flutes of the second corrugating medium 11 do not interfere with each other to prevent the breakage of the flutes thereof, thus permitting a high-quality single-faced corrugated fiberboard sheet 13 to be producible.

Still further, since all the adhesions (the adhesion between the first corrugating medium 10 and the second corrugating medium 11, and the adhesion between the adhesion of the first and second corrugating mediums 10, 11 and the liner 12) needed for manufacturing the single-faced corrugated fiberboard sheet 13 are done on the same upper roller 3, a compact apparatus is obtainable.

Incidentally, although the single-faced corrugated fiberboard sheet manufacturing apparatus according to the embodiment of this invention has been described as an apparatus for manufacturing a single-faced corrugated fiberboard sheet having two corrugating medium layers, the apparatus according to this embodiment is not limited to the two corrugating medium layers, but can also be constructed as an apparatus for manufacturing a single-faced corrugated fiberboard sheet comprising a plurality of (for example, 3) corrugating medium layers exceeding the two corrugating medium layers.

In this case, since there is a need to form corrugated configurations with flutes different in height from each other on the corrugating medium whose number corresponds to the number of layers, a plurality of flute making rolls with flutes different in height from each other, corresponding to the number of layers, are necessary to prepare. In the case of using the plurality of flute making rolls with flutes different in height from each other, the corrugating roll with high flutes is located on the upstream side of the upper roller 3 in its rotating direction, and the corrugating rolls with lower flutes are disposed in order toward the downstream side in the rotating direction.

Thus, as well as the above-described embodiment, the adhesion among the plurality of corrugating mediums can be done on the same upper roller 3 without causing the pitch slippage or phase shift between the corrugating mediums, thus manufacturing a high-quality single-faced corrugated fiberboard sheet.

In addition, in the single-faced corrugated fiberboard sheet manufacturing apparatus according to this embodiment, although the pressure belt 1′ is disposed above the upper roller 3 while the first corrugating medium flute making section 16 and the second corrugating medium flute making section 17 are placed under the upper roller 3, it is also appropriate that the pressure belt 1′ is placed under the upper roller 3 while the first corrugating medium flute making section 16 and the second corrugating medium flute making section 17 are situated above the upper roller 3.

Furthermore, in the single-faced corrugated fiberboard sheet manufacturing apparatus according to this embodiment, although the flutes of the second corrugating medium 11 are formed by the second lower roller 4 and the pressure roller 6 of the second corrugating medium flute making section 17, it is also possible that a second lower roller engaging with the upper roller 3 is constructed as a pressure roller for pressing the corrugating medium 11 toward the upper roller 3 side and the second corrugating medium 11 is introduced into the gap between the upper roller 3 and the second lower roller 4 where flutes are made on the second corrugating medium 11. In this case, one roller is omissible. Further, in this case, the upper roller 3 functions as a corrugating roll.

Still further, in the single-faced corrugated fiberboard sheet manufacturing apparatus according to this embodiment, although the adhesion of the first and second corrugating mediums 10, 11 and the liner 12 are pressurized by the pressure unit 1 including the pressure belt 1′ to be adhered to each other, in place of the pressure unit 1 including the pressure belt 1′, it is also appropriate that the pressure unit 1 includes a pressure roller and the adhesion of the first and second corrugating mediums 10, 11 and the liner 12 are pressurized by such a pressure roller. In this case, it is necessary to adjust the pressing force to an appropriate value to prevent the occurrence of press marks.

Moreover, in the single-faced corrugated fiberboard sheet manufacturing apparatus according to this embodiment, although the height of the flutes of the second lower roller 4 of the second corrugating medium flute making section 17 is made to be equal to that of the upper roller 3, this invention is not limited to this, but it is also possible that the height of the flutes of the upper roller 3 is set to be greater than that of the second lower roller 4.

What is claimed is:

1. A single-faced corrugated fiberboard sheet manufacturing apparatus for manufacturing a single-faced corrugated fiberboard sheet by adhering a plurality of corrugating mediums and a liner to each other, said apparatus comprising:
a plurality of corrugating rolls provided for each of said plurality of corrugating mediums and equipped with flutes different in height from each other to shape said plurality of corrugating mediums into corrugated configurations with flutes different in height from each other;
an applicator roll engaged with all of said plurality of corrugating rolls and made to guide said plurality of corrugating mediums, formed into the corrugated configurations, in an adhered condition; and
a pressure unit disposed in an opposed relation to said applicator roll to pressurize said plurality of corrugating mediums and said liner to assist adhesion therebetween,
wherein said applicator roll has flutes equal to or higher than the highest flute of said flutes of said plurality of corrugating rolls, and
adhesion between said plurality of corrugating mediums and the adhesion of said liner to said plurality of corrugating mediums are conducted on said same applicator roll.

2. A single-faced corrugated fiberboard sheet manufacturing apparatus as defined in claim 1, wherein said pressure unit includes:
a pressure belt for bringing said plurality of corrugating mediums, guided in an adhered condition along an outer circumferential surface of said applicator roll, and said liner into pressurizing contact with said applicator roll; and
belt rollers around which said pressure belt is wound.

3. A single-faced corrugated fiberboard sheet manufacturing apparatus as defined in claim 2, wherein the adhesion of said liner to said plurality of corrugating mediums is made at a portion where said pressure belt is brought into pressurizing contact with said applicator roll.

4. A single-faced corrugated fiberboard sheet manufacturing apparatus as defined in claim 1, wherein the adhesion between said plurality of corrugating mediums is made in a manner that flute peak portions of said corrugating mediums shaped into a corrugated configuration with high flutes are adhered to bottom portions between said flutes on said corrugating mediums shaped into a corrugated configuration with low flutes.

5. A single-faced corrugated fiberboard sheet manufacturing apparatus as defined in claim 1, wherein the adhesion between said plurality of corrugating mediums is made at a portion where said applicator roll engages with said corrugating roll with low flutes.

6. A single-faced corrugated fiberboard sheet manufacturing apparatus as defined in claim 1, further comprising a plurality of pressure rollers provided to respectively engage with said plurality of corrugating rolls, said plurality of corrugating mediums being introduced into between said plurality of pressure rollers and said plurality of corrugating rolls to form corrugated configurations with different flutes on said plurality of corrugating mediums, respectively.

7. A single-faced corrugated fiberboard sheet manufacturing apparatus as defined in any one of claims 1 to 6, wherein, of said plurality of corrugating rolls, said corrugating rolls with high flutes are located on the upstream side in a rotating direction of said applicator roll, and said corrugating rolls with lower flutes are disposed in order toward the downstream side in the rotating direction.

8. A single-faced corrugated fiberboard sheet manufacturing method of producing a single-faced corrugated fiberboard sheet by adhering a plurality of corrugating mediums to a liner, comprising the steps of:
shaping said corrugating mediums by a corrugating roll with high flutes into a corrugated configuration with high flutes:
introducing said corrugating mediums, shaped into the corrugated configuration with high flutes, onto an applicator roll gearing with said corrugating roll with high flutes so that said corrugating medium is guided by said applicator roll;
shaping said corrugating medium by a corrugating roll with low flutes into a corrugated configuration with low flutes;
introducing said corrugating medium, shaped into the corrugated configuration with low flutes, onto said applicator roll engaging with said corrugating roll with low flutes so that it comes into an adhered condition with said corrugating medium shaped into the corrugated configuration with high flutes and guided by said applicator roll:
adhering said corrugating medium shaped into the corrugated configuration with high flutes and said corrugating medium shaped into the corrugated configuration with low flutes to each other on said applicator roll engaging with said corrugating roll with low flutes;
guiding the adhered corrugating mediums in an adhered condition by said applicator roll in a state where said flutes of the adhered corrugating mediums are put in flutes formed between said flutes of said applicator roll with high flutes to maintain the configurations:
introducing said liner onto said applicator roll to come into an adhered condition with the adhered corrugating mediums guided by said applicator roll; and
pressurizing said liner and the adhered corrugating mediums by a pressure unit to adhere them to each other on said same applicator roll.
